(19) United States
(12) Patent Application Publication
(10) Pub. No.: US 2019/0075583 A1
(43) Pub. Date: Mar. 7, 2019

(54) METHOD FOR UPLINK TRANSMISSION, AND WIRELESS TERMINAL USING METHOD IN WIRELESS LAN SYSTEM

(71) Applicant: LG ELECTRONICS INC., Seoul (KR)

(72) Inventors: Hyunhee PARK, Seoul (KR); Kiseon RYU, Seoul (KR); Suhwook KIM, Seoul (KR); Jeongki KIM, Seoul (KR); Hangyu CHO, Seoul (KR)

(73) Assignee: LG ELECTRONICS INC., Seoul (KR)

(21) Appl. No.: 16/093,605

(22) PCT Filed: Apr. 17, 2017
(86) PCT No.: PCT/KR2017/004097

§ 371 Date: Oct. 12, 2018

Related U.S. Application Data
(60) Provisional application No. 62/323,817, filed on Apr. 18, 2016.
(60) Provisional application No. 62/333,889, filed on May 10, 2016.

(51) Int. Cl. H04W 72/12; H04W 74/04; H04W 28/02; H04W 28/06

(52) U.S. Cl. CPC H04W 72/1268; H04W 74/04; H04W 28/0278; H04L 5/0037; H04W 28/06; H04W 28/0289; H04W 28/0268

(57) ABSTRACT

A method for an uplink transmission in a wireless LAN system according to one embodiment of the present specification comprises the steps of: transmitting, to an AP, buffer state information for reporting the buffer state of a user STA, the buffer state information comprising a scaling factor configured by the user STA on the basis of a plurality of weighted values for indicating the amount of buffered traffic in the user STA; and transmitting an uplink as a response for a trigger frame when the trigger frame, generated on the basis of the buffer status information, is received from the AP, wherein the trigger frame is a frame comprising a plurality of uplink resource units individually allocated for a plurality of user STAs.

### BACKGROUND OF THE INVENTION

### Field of the Invention

This specification relates to wireless communication and, most particularly, to a method for uplink transmission, and a wireless device using the method in a wireless local area network system.

### Related Art

A next-generation WLAN is aimed at 1) improving Institute of Electrical and Electronics Engineers (IEEE) 802.11 physical (PHY) and medium access control (MAC) layers in bands of 2.4 GHz and 5 GHz, 2) increasing spectrum efficiency and area throughput, and 3) improving performance in actual indoor and outdoor environments, such as an environment in which an interference source exists, a dense heterogeneous network environment, and an environment in which a high user load exists.

In the next-generation WLAN, a dense environment having a great number of access points (APs) and stations (STAs) is primarily considered. Discussions have been conducted on improvement in spectrum efficiency and area throughput in this dense environment. The next-generation WLAN pays attention to actual performance improvement not only in an indoor environment but also in an outdoor environment, which is not significantly considered in the existing WLAN.

Specifically, scenarios for a wireless office, a smart home, a stadium, a hotspot, and the like receive attention in the next-generation WLAN. Discussions are ongoing on improvement in the performance of a WLAN system in the dense environment including a large number of APs and STAs based on relevant scenarios.

### SUMMARY OF THE INVENTION

### Technical Objects

An object of this specification is to provide a method for uplink transmission, and a wireless device using the method in a wireless system having enhanced capability (or performance).

### Technical Solutions

This specification relates to a method for uplink transmission in a wireless system. The method for uplink transmission in a WLAN system according to an exemplary embodiment of this specification may include the steps of transmitting buffer status information for reporting a buffer status of a user STA to an access point (AP), wherein the buffer status information includes a scaling factor being configured by the user STA based on a plurality of weighted values for indicating a traffic size being buffered to the user STA, and, if a trigger frame being generated based on the buffer status information is received from the AP, performing uplink transmission as a response to the trigger frame, wherein the trigger frame corresponds to a frame including a plurality of uplink resource units being separately assigned for a plurality of user STAs.

### Effects of the Invention

According to an exemplary embodiment of this specification, provided herein is a method for uplink transmission, and a wireless device using method in a wireless system having enhanced capability (or performance).

### BRIEF DESCRIPTION OF THE DRAWINGS

FIG. 1 is a conceptual view illustrating the structure of a wireless local area network (WLAN).

FIG. 2 is a diagram illustrating an example of a PPDU used in an IEEE standard.

FIG. 3 is a diagram illustrating an example of an HE PDDU.

FIG. 4 is a diagram illustrating a layout of resource units used in a band of 20 MHz.

FIG. 5 is a diagram illustrating a layout of resource units used in a band of 40 MHz.

FIG. 6 is a diagram illustrating a layout of resource units used in a band of 80 MHz.

FIG. 7 is a diagram illustrating another example of the HE PPDU.

FIG. 8 is a block diagram illustrating one example of HE-SIG-B.

FIG. 9 illustrates an example of a trigger frame.

FIG. 10 illustrates an example of a sub-field included in a per user information field.

FIG. 11 illustrates an example of a sub-field being included in a per user information.

FIG. 12 illustrates a conceptual diagram of an STA performing an EDCA-based channel access in a WLAN system according to an exemplary embodiment of this specification.

FIG. 13 is a conceptual diagram illustrating a backoff procedure of an EDCA in a WLAN system according to an exemplary embodiment of this specification.

FIG. 14 is a diagram for describing a backoff cycle and a frame transmission procedure in a WLAN system of this specification.

FIG. 15 illustrates an example of a MAC frame for reporting a buffer status according to an exemplary embodiment of this specification.

FIG. 16 is a diagram illustrating a field region of a MAC frame for reporting a buffer status according to an exemplary embodiment of this specification.

FIG. 17 is a diagram illustrating detailed operations of reporting a buffer status of a user STA based on buffer status information included in a control information field according to an exemplary embodiment of this specification.

FIG. 18 is a diagram showing an exemplary method for transmitting an uplink frame in a wireless LAN system according to an exemplary embodiment of this specification.

FIG. 19 is a block view illustrating a wireless device to which the exemplary embodiment of this specification can be applied.

### DESCRIPTION OF EXEMPLARY EMBODIMENTS

The aforementioned features and following detailed descriptions are provided for exemplary purposes to facilitate explanation and understanding of the present specification. That is, the present specification is not limited to such an embodiment and thus may be embodied in other forms. The following embodiments are examples only for completely disclosing the present specification and are intended to convey the present specification to those ordinarily skilled in the art to which the present specification pertain. Therefore, where there are several ways to implement constitutional elements of the present specification, it is necessary to clarify that the implementation of the present specification is possible by using a specific method among these methods or any of its equivalents.

When it is mentioned in the present specification that a certain configuration includes particular elements, or when it is mentioned that a certain process includes particular steps, it means that other elements or other steps may be further included. That is, the terminology used herein is for the purpose of describing particular embodiments only, and is not intended to limit the concept of the present specification. Further, embodiments described to help understanding of the invention also includes complementary embodiments thereof.

Terms used in the present specification have the meaning as commonly understood by those ordinarily skilled in the art to which the present specification pertains. Commonly used terms should be interpreted as having a meaning that is consistent with their meaning in the context of the present specification. Further, terms used in the present specification should not be interpreted in an excessively idealized or formal sense unless otherwise defined. Hereinafter, an embodiment of the present specification is described with reference to the accompanying drawings.

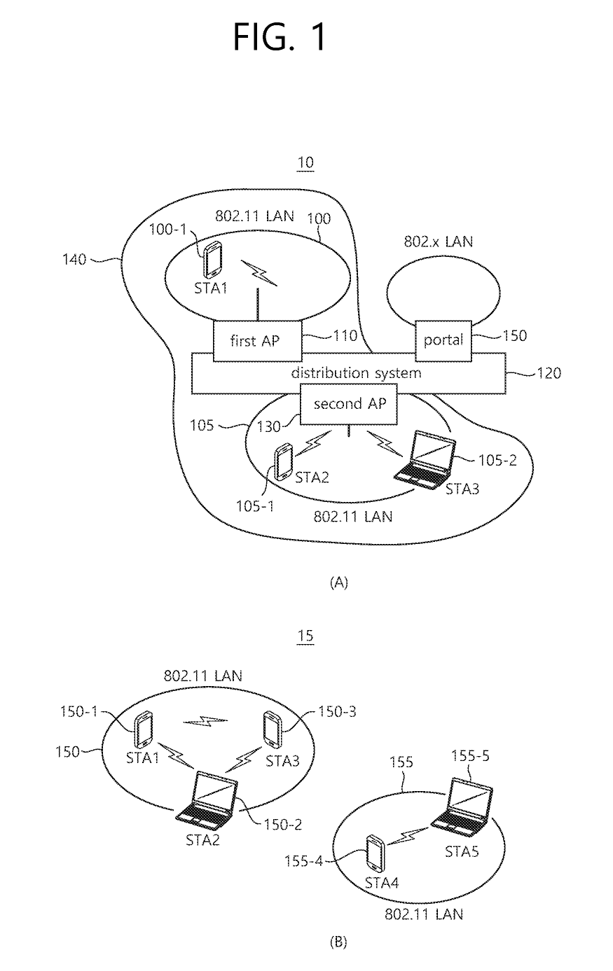

FIG. 1 is a conceptual view illustrating the structure of a wireless local area network (WLAN). FIG. 1(A) illustrates the structure of an infrastructure basic service set (BSS) of institute of electrical and electronic engineers (IEEE) 802.11.

Referring the FIG. 1(A), the WLAN system 10 of the FIG. 1(A) may include one or more infrastructure BSSs (100, 105) (hereinafter, referred to as BSS). The BSSs (100, 105) as a set of an access point (hereinafter, referred to as AP) and a station (hereinafter, referred to STA), such as an AP (110) and a STA1 (100-1), which are successfully synchronized to communicate with each other are not concepts indicating a specific region.

For example, the BSS (100) may include one AP (110) and one or more STAs (100-1) which may be associated with one AP (110). The BSS (105) may include one or more STAs (105-1, 105-2) which may be associated with one AP (130).

The infrastructure BSS (100, 105) may include at least one STA, APs (110, 130) providing a distribution service, and a distribution system (DS) (120) connecting multiple APs.

The distribution system (120) may implement an extended service set (ESS) (140) extended by connecting the multiple BSSs (100, 105). The ESS (140) may be used as a term indicating one network configured by connecting one or more APs (110, 130) through the distribution system (120). The AP included in one ESS (140) may have the same service set identification (SSID).

A portal (150) may serve as a bridge which connects the WLAN network (IEEE 802.11) and another network (e.g., 802.X).

In the BSS illustrated in the FIG. 1(A), a network between the APs (110, 130) and a network between the APs (110, 130) and the STAs (100-1, 105-1, 105-2) may be implemented.

FIG. 1(B) illustrates a conceptual view illustrating the IBSS. Referring to FIG. 1(B), a WLAN system (15) of FIG. 1(B) may be capable of performing communication by configuring a network between STAs in the absence of the APs (110, 130) unlike in FIG. 1(A). When communication is performed by configuring the network also between the STAs in the absence of the AP (110, 130), the network is defined as an ad-hoc network or an independent basic service set (IBSS).

Referring to the FIG. 1(B), the IBSS is a BSS that operates in an Ad-Hoc mode. Since the IBSS does not include the access point (AP), a centralized management entity that performs a management function at the center does not exist. That is, in the IBSS (15), STAs (150-1, 150-2, 150-3, 155-4, 155-5) are managed by a distributed manner.

In the IBSS, all STAs (150-1, 150-2, 150-3, 155-4, 155-5) may be constituted as movable STAs and are not permitted (or authorized) to access the DS to constitute a self-contained network.

The STA as a predetermined functional medium that includes a medium access control (MAC) that follows a regulation of an Institute of Electrical and Electronics Engineers (IEEE) 802.11 standard and a physical layer interface for a radio medium may be used as a meaning including all of the APs and the non-AP stations (STAs).

The STA may be called by various names such as a mobile terminal, a wireless device, a wireless transmit/receive unit (WTRU), user equipment (UE), a mobile station (MS), a mobile subscriber unit, or simply a user.

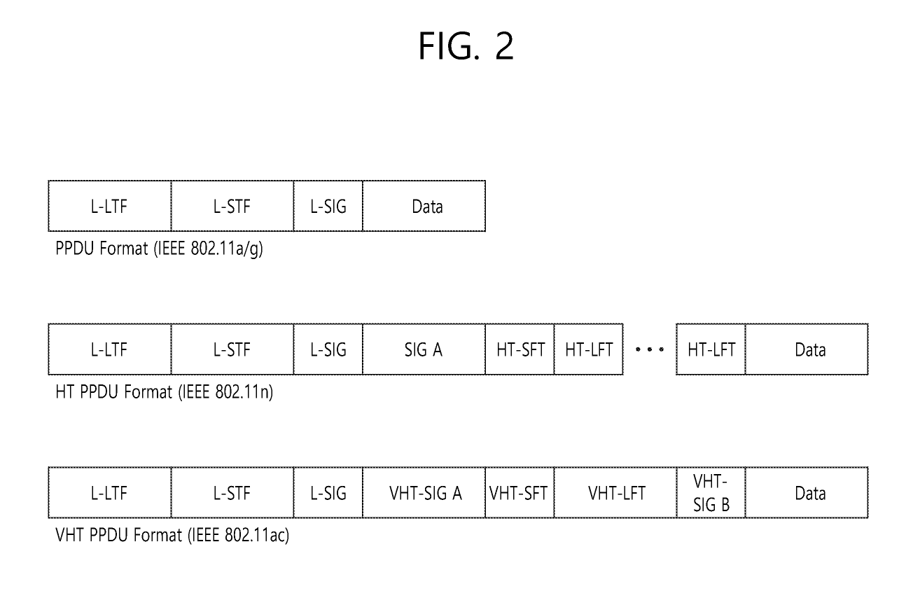

FIG. 2 is a diagram illustrating an example of a PPDU used in an IEEE standard.

As illustrated in FIG. 2, various types of PHY protocol data units (PPDUs) may be used in a standard such as IEEE a/g/n/ac, etc. In detail, LTF and STF fields include a training signal, SIG-A and SIG-B include control information for a receiving station, and a data field includes user data corresponding to a PSDU.

In the embodiment, an improved technique is provided, which is associated with a signal (alternatively, a control information field) used for the data field of the PPDU. The signal provided in the embodiment may be applied onto high efficiency PPDU (HE PPDU) according to an IEEE 802.11ax standard. That is, the signal improved in the embodiment may be HE-SIG-A and/or HE-SIG-B included in the HE PPDU. The HE-SIG-A and the HE-SIG-B may be represented even as the SIG-A and SIG-B, respectively. However, the improved signal proposed in the embodiment is not particularly limited to an HE-SIG-A and/or HE-SIG-B standard and may be applied to control/data fields having various names, which include the control information in a wireless communication system transferring the user data.

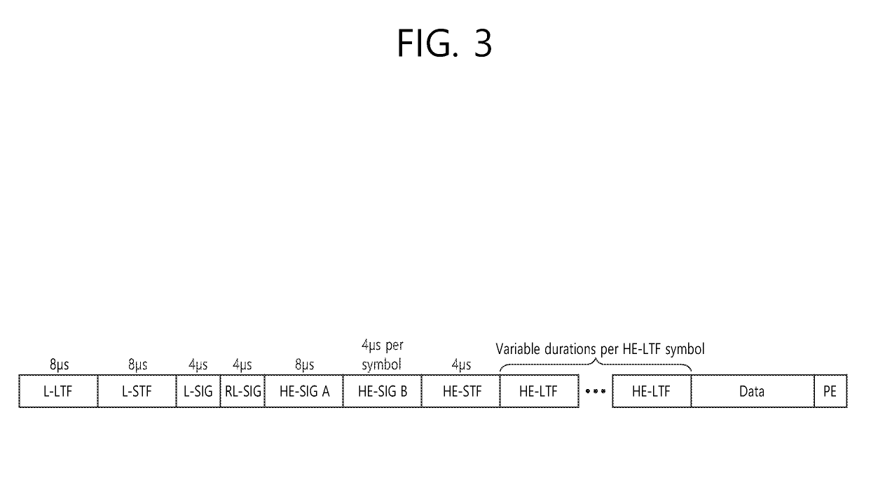

FIG. 3 is a diagram illustrating an example of an HE PDDU.

The control information field provided in the embodiment may be the HE-SIG-B included in the HE PPDU. The HE PPDU according to FIG. 3 is one example of the PPDU for multiple users and only the PPDU for the multiple users may include the HE-SIG-B and the corresponding HE SIG-B may be omitted in a PPDU for a single user.

As illustrated in FIG. 3, the HE-PPDU for multiple users (MUs) may include a legacy-short training field (L-STF), a legacy-long training field (L-LTF), a legacy-signal (L-SIG), a high efficiency-signal A (HE-SIG A), a high efficiency-signal-B (HE-SIG B), a high efficiency-short training field (HE-STF), a high efficiency-long training field (HE-LTF), a data field (alternatively, an MAC payload), and a packet extension (PE) field. The respective fields may be transmitted during an illustrated time period (that is, 4 or 8 μs). More detailed description of the respective fields of FIG. 3 will be made below.

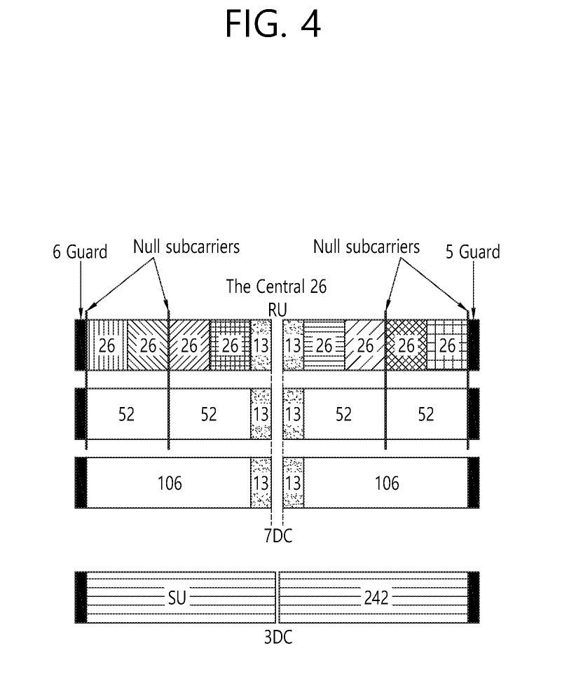

FIG. 4 is a diagram illustrating a layout of resource units (RUs) used in a band of 20 MHz. As illustrated in FIG. 4, resource units (RUs) corresponding to tone (that is, subcarriers) of different numbers are used to constitute some fields of the HE-PPDU. For example, the resources may be allocated by the unit of the RU illustrated for the HE-STF, the HE-LTF, and the data field.

As illustrated in an uppermost part of FIG. 4, 26 units (that is, units corresponding to 26 tones). 6 tones may be used as a guard band in a leftmost band of the 20 MHz band and 5 tones may be used as the guard band in a rightmost band of the 20 MHz band. Further, 7 DC tones may be inserted into a center band, that is, a DC band and a 26-unit corresponding to each 13 tones may be present at left and right sides of the DC band. The 26-unit, a 52-unit, and a 106-unit may be allocated to other bands. Each unit may be allocated for a receiving station, that is, a user.

Meanwhile, the RU layout of FIG. 4 may be used even in a situation for a single user (SU) in addition to the multiple users (MUs) and, in this case, as illustrated in a lowermost part of FIG. 4, one 242-unit may be used and, in this case, three DC tones may be inserted.

In one example of FIG. 4, RUs having various sizes, that is, a 26-RU, a 52-RU, a 106-RU, a 242-RU, and the like are proposed, and as a result, since detailed sizes of the RUs may extend or increase, the embodiment is not limited to a detailed size (that is, the number of corresponding tones) of each RU.

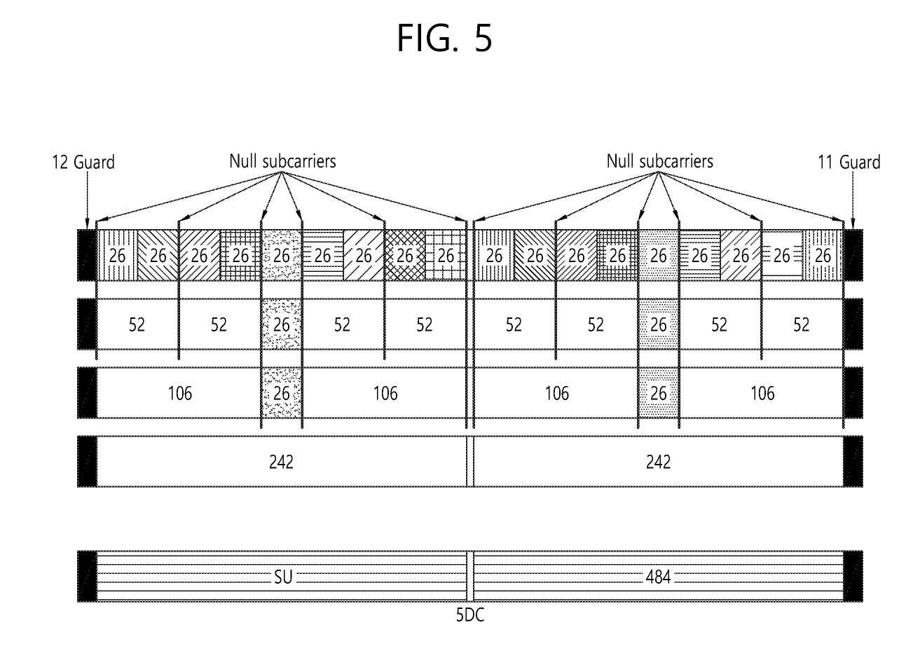

FIG. 5 is a diagram illustrating a layout of resource units (RUs) used in a band of 40 MHz.

Similarly to a case in which the RUs having various RUs are used in one example of FIG. 4, 26-RU, 52-RU, 106-RU, 242-RU, 484-RU, and the like may be used even in one example of FIG. 5. Further, 5 DC tones may be inserted into a center frequency, 12 tones may be used as the guard band in the leftmost band of the 40 MHz band and 11 tones may be used as the guard band in the rightmost band of the 40 MHz band.

In addition, as illustrated in FIG. 5, when the RU layout is used for the single user, the 484-RU may be used. That is, the detailed number of RUs may be modified similarly to one example of FIG. 4.

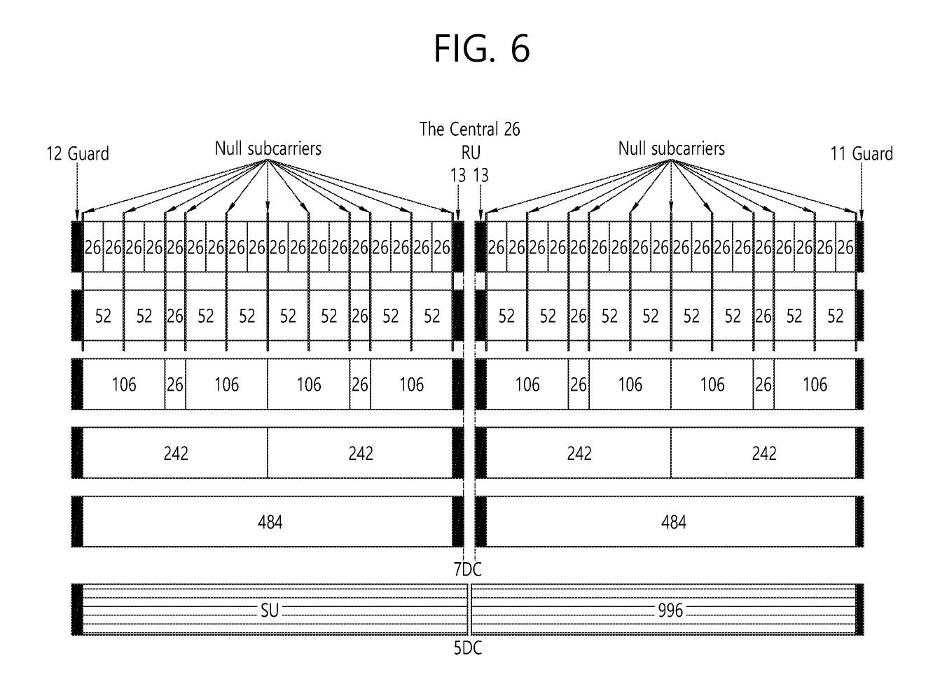

FIG. 6 is a diagram illustrating a layout of resource units (RUs) used in a band of 80 MHz.

Similarly to a case in which the RUs having various RUs are used in one example of each of FIG. 4 or 5, 26-RU, 52-RU, 106-RU, 242-RU, 484-RU, and the like may be used even in one example of FIG. 6. Further, 7 DC tones may be inserted into the center frequency, 12 tones may be used as the guard band in the leftmost band of the 80 MHz band and 11 tones may be used as the guard band in the rightmost band of the 80 MHz band. In addition, the 26-RU may be used, which uses 13 tones positioned at each of left and right sides of the DC band.

Moreover, as illustrated in FIG. 6, when the RU layout is used for the single user, 996-RU may be used and, in this case, 5 DC tones may be inserted. Meanwhile, the detailed number of RUs may be modified similarly to one example of each of FIG. 4 and FIG. 5.

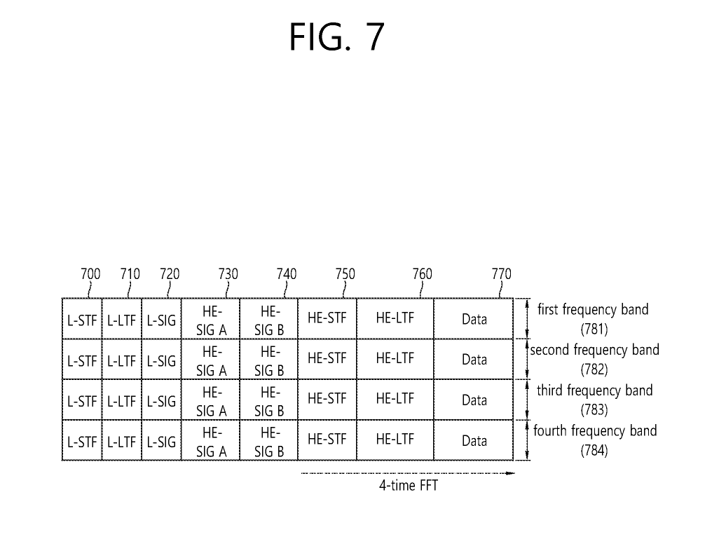

FIG. 7 is a diagram illustrating another example of the HE PPDU.

A block illustrated in FIG. 7 is another example of describing the HE-PPDU block of FIG. 3 in terms of a frequency.

An illustrated L-STF (700) may include a short training orthogonal frequency division multiplexing (OFDM) symbol. The L-STF (700) may be used for frame detection, automatic gain control (AGC), diversity detection, and coarse frequency/time synchronization.

An L-LTF (710) may include a long training orthogonal frequency division multiplexing (OFDM) symbol. The L-LTF (710) may be used for fine frequency/time synchronization and channel prediction.

An L-SIG (720) may be used for transmitting control information. The L-SIG (720) may include information regarding a data rate and a data length. Further, the L-SIG (720) may be repeatedly transmitted. That is, a new format, in which the L-SIG (720) is repeated (e.g., may be referred to as R-LSIG) may be configured.

An HE-SIG-A (730) may include the control information common to the receiving station.

In detail, the HE-SIG-A (730) may include information on 1) a DL/UL indicator, 2) a BSS color field indicating an identify of a BSS, 3) a field indicating a remaining time of a current TXOP period, 4) a bandwidth field indicating at least one of 20, 40, 80, 160 and 80+80 MHz, 5) a field indicating an MCS technique applied to the HE-SIG-B, 6) an indication field regarding whether the HE-SIG-B is modulated by a dual subcarrier modulation technique for MCS, 7) a field indicating the number of symbols used for the HE-SIG-B, 8) a field indicating whether the HE-SIG-B is configured for a full bandwidth MIMO transmission, 9) a field indicating the number of symbols of the HE-LTF, 10) a field indicating the length of the HE-LTF and a CP length, 11) a field indicating whether an OFDM symbol is present for LDPC coding, 12) a field indicating control information regarding packet extension (PE), 13) a field indicating information on a CRC field of the HE-SIG-A, and the like. A detailed field of the HE-SIG-A may be added or partially omitted. Further, some fields of the HE-SIG-A may be partially added or omitted in other environments other than a multi-user (MU) environment

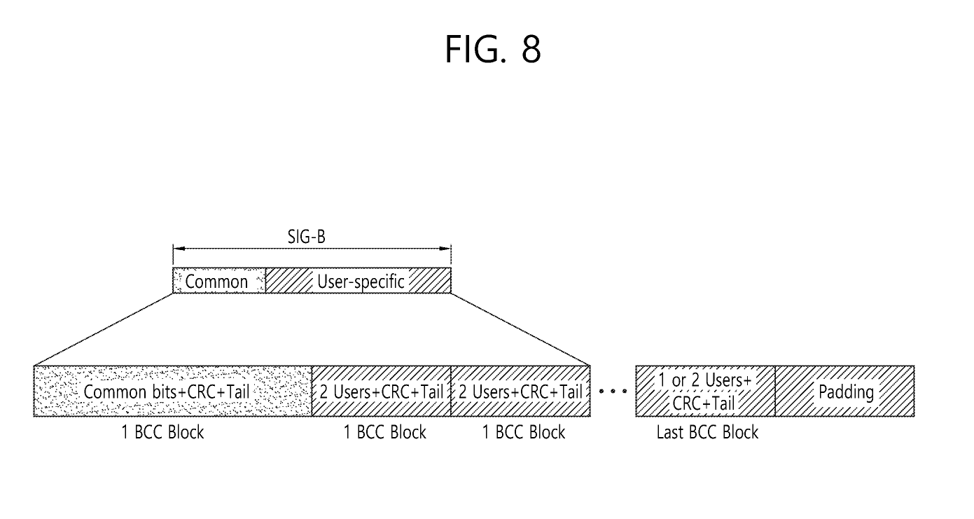

An HE-SIG-B (740) may be included only in the case of the PPDU for the multiple users (MUs) as described above. Principally, an HE-SIG-A (750) or an HE-SIG-B (760) may include resource allocation information (alternatively, virtual resource allocation information) for at least one receiving STA. The HE-SIG-B (740) will be described below in a greater detail with reference to FIG. 8.

A previous field of the HE-SIG-B (740) may be transmitted in a duplicated form on an MU PPDU. In the case of the HE-SIG-B (740), the HE-SIG-B (740) transmitted in some frequency band (e.g., a fourth frequency band) may even include control information for a data field corresponding to a corresponding frequency band (that is, the fourth frequency band) and a data field of another frequency band (e.g., a second frequency band) other than the corresponding frequency band. Further, a format may be provided, in which the HE-SIG-B (740) in a specific frequency band (e.g., the second frequency band) is duplicated with the HE-SIG-B (740) of another frequency band (e.g., the fourth frequency band). Alternatively, the HE-SIG B (740) may be transmitted in an encoded form on all transmission resources. A field after the HE-SIG B (740) may include individual information for respective receiving STAs receiving the PPDU.

The HE-STF (750) may be used for improving automatic gain control estimation in a multiple input multiple output (MIMO) environment or an OFDMA environment.

The HE-LTF (760) may be used for estimating a channel in the MIMO environment or the OFDMA environment.

The size of fast Fourier transform (FFT)/inverse fast Fourier transform (IFFT) applied to the HE-STF (750) and the field after the HE-STF (750), and the size of the FFT/IFFT applied to the field before the HE-STF (750) may be different from each other. For example, the size of the FFT/IFFT applied to the HE-STF (750) and the field after the HE-STF (750) may be four times larger than the size of the FFT/IFFT applied to the field before the HE-STF (750).

For example, when at least one field of the L-STF (700), the L-LTF (710), the L-SIG (720), the HE-SIG-A (730), and the HE-SIG-B (740) on the PPDU of FIG. 7 is referred to as a first field, at least one of the data field (770), the HE-STF (750), and the HE-LTF (760) may be referred to as a second field. The first field may include a field associated with a legacy system and the second field may include a field associated with an HE system. In this case, the fast Fourier transform (FFT) size and the inverse fast Fourier transform (IFFT) size may be defined as a size which is N (N is a natural number, e.g., N=1, 2, and 4) times larger than the FFT/IFFT size used in the legacy WLAN system. That is, the FFT/IFFT having the size may be applied, which is N(=4) times larger than the first field of the HE PPDU. For example, 256 FFT/IFFT may be applied to a bandwidth of 20 MHz, 512 FFT/IFFT may be applied to a bandwidth of 40 MHz, 1024 FFT/IFFT may be applied to a bandwidth of 80 MHz, and 2048 FFT/IFFT may be applied to a bandwidth of continuous 160 MHz or discontinuous 160 MHz.

In other words, a subcarrier space/subcarrier spacing may have a size which is 1/N times (N is the natural number, e.g., N=4, the subcarrier spacing is set to 78.125 kHz) the subcarrier space used in the legacy WLAN system. That is, subcarrier spacing having a size of 312.5 kHz, which is legacy subcarrier spacing may be applied to the first field of the HE PPDU and a subcarrier space having a size of 78.125 kHz may be applied to the second field of the HE PPDU.

Alternatively, an IDFT/DFT period applied to each symbol of the first field may be expressed to be N(=4) times shorter than the IDFT/DFT period applied to each data symbol of the second field. That is, the IDFT/DFT length applied to each symbol of the first field of the HE PPDU may be expressed as 3.2 μs and the IDFT/DFT length applied to each symbol of the second field of the HE PPDU may be expressed as 3.2 μs*4(=12.8 μs). The length of the OFDM symbol may be a value acquired by adding the length of a guard interval (GI) to the IDFT/DFT length. The length of the GI may have various values such as 0.4 μs, 0.8 μs, 1.6 μs, 2.4 μs, and 3.2 μs.

For simplicity in the description, in FIG. 7, it is expressed that a frequency band used by the first field and a frequency band used by the second field accurately coincide with each other, but both frequency bands may not completely coincide with each other, in actual. For example, a primary band of the first field (L-STF, L-LTF, L-SIG, HE-SIG-A, and HE-SIG-B) corresponding to the first frequency band may be the same as the most portions of a frequency band of the second field (HE-STF, HE-LTF, and Data), but boundary surfaces of the respective frequency bands may not coincide with each other. As illustrated in FIGS. 4 to 6, since multiple null subcarriers, DC tones, guard tones, and the like are inserted during arranging the RUs, it may be difficult to accurately adjust the boundary surfaces.

The user (e.g., a receiving station) may receive the HE-SIG-A (730) and may be instructed to receive the downlink PPDU based on the HE-SIG-A (730). In this case, the STA may perform decoding based on the FFT size changed from the HE-STF (750) and the field after the HE-STF (750). On the contrary, when the STA may not be instructed to receive the downlink PPDU based on the HE-SIG-A (730), the STA may stop the decoding and configure a network allocation vector (NAV). A cyclic prefix (CP) of the HE-STF (750) may have a larger size than the CP of another field and the during the CP period, the STA may perform the decoding for the downlink PPDU by changing the FFT size.

Hereinafter, in the embodiment of this specification, data (alternatively, or a frame) which the AP transmits to the STA may be expressed as a term called downlink data (alternatively, a downlink frame), and data (alternatively, a frame) which the STA transmits to the AP may be expressed as a term called uplink data (alternatively, an uplink frame). Further, transmission from the AP to the STA may be expressed as downlink transmission and transmission from the STA to the AP may be expressed as a term called uplink transmission.

In addition, a PHY protocol data unit (PPDU), a frame, and data transmitted through the downlink transmission may be expressed as terms such as a downlink PPDU, a downlink frame, and downlink data, respectively. The PPDU may be a data unit including a PPDU header and a physical layer service data unit (PSDU) (alternatively, a MAC protocol data unit (MPDU)). The PPDU header may include a PHY header and a PHY preamble and the PSDU (alternatively, MPDU) may include the frame or indicate the frame (alternatively, an information unit of the MAC layer) or be a data unit indicating the frame. The PHY header may be expressed as a physical layer convergence protocol (PLCP) header as another term and the PHY preamble may be expressed as a PLCP preamble as another term.

Further, a PPDU, a frame, and data transmitted through the uplink transmission may be expressed as terms such as an uplink PPDU, an uplink frame, and uplink data, respectively.

In the WLAN system to which the embodiment of the present description is applied, the whole bandwidth may be used for downlink transmission to one STA and uplink transmission to one STA. Further, in the WLAN system to which the embodiment of the present description is applied, the AP may perform downlink (DL) multi-user (MU) transmission based on multiple input multiple output (MU MIMO) and the transmission may be expressed as a term called DL MU MIMO transmission.

In addition, in the WLAN system according to the embodiment, an orthogonal frequency division multiple access (OFDMA) based transmission method is preferably supported for the uplink transmission and/or downlink transmission. That is, data units (e.g., RUs) corresponding to different frequency resources are allocated to the user to perform uplink/downlink communication. In detail, in the WLAN system according to the embodiment, the AP may perform the DL MU transmission based on the OFDMA and the transmission may be expressed as a term called DL MU OFDMA transmission. When the DL MU OFDMA transmission is performed, the AP may transmit the downlink data (alternatively, the downlink frame and the downlink PPDU) to the plurality of respective STAs through the plurality of respective frequency resources on an overlapped time resource. The plurality of frequency resources may be a plurality of subbands (alternatively, sub channels) or a plurality of resource units (RUs). The DL MU OFDMA transmission may be used together with the DL MU MIMO transmission. For example, the DL MU MIMO transmission based on a plurality of space-time streams (alternatively, spatial streams) may be performed on a specific subband (alternatively, sub channel) allocated for the DL MU OFDMA transmission.

Further, in the WLAN system according to the embodiment, uplink multi-user (UL MU) transmission in which the plurality of STAs transmits data to the AP on the same time resource may be supported. Uplink transmission on the overlapped time resource by the plurality of respective STAs may be performed on a frequency domain or a spatial domain.

When the uplink transmission by the plurality of respective STAs is performed on the frequency domain, different frequency resources may be allocated to the plurality of respective STAs as uplink transmission resources based on the OFDMA. The different frequency resources may be different subbands (alternatively, sub channels) or different resources units (RUs). The plurality of respective STAs may transmit uplink data to the AP through different frequency resources. The transmission method through the different frequency resources may be expressed as a term called a UL MU OFDMA transmission method.

When the uplink transmission by the plurality of respective STAs is performed on the spatial domain, different time-space streams (alternatively, spatial streams) may be allocated to the plurality of respective STAs and the plurality of respective STAs may transmit the uplink data to the AP through the different time-space streams. The transmission method through the different spatial streams may be expressed as a term called a UL MU MIMO transmission method.

The UL MU OFDMA transmission and the UL MU MIMO transmission may be used together with each other. For example, the UL MU MIMO transmission based on the plurality of space-time streams (alternatively, spatial streams) may be performed on a specific subband (alternatively, sub channel) allocated for the UL MU OFDMA transmission.

In the legacy WLAN system which does not support the MU OFDMA transmission, a multi-channel allocation method is used for allocating a wider bandwidth (e.g., a 20 MHz excess bandwidth) to one terminal. When a channel unit is 20 MHz, multiple channels may include a plurality of 20 MHz-channels. In the multi-channel allocation method, a primary channel rule is used to allocate the wider bandwidth to the terminal. When the primary channel rule is used, there is a limit for allocating the wider bandwidth to the terminal. In detail, according to the primary channel rule, when a secondary channel adjacent to a primary channel is used in an overlapped BSS (OBSS) and is thus busy, the STA may use remaining channels other than the primary channel. Therefore, since the STA may transmit the frame only to the primary channel, the STA receives a limit for transmission of the frame through the multiple channels. That is, in the legacy WLAN system, the primary channel rule used for allocating the multiple channels may be a large limit in obtaining a high throughput by operating the wider bandwidth in a current WLAN environment in which the OBSS is not small.

In order to solve the problem, in the embodiment, a WLAN system is disclosed, which supports the OFDMA technology. That is, the OFDMA technique may be applied to at least one of downlink and uplink. Further, the MU-MIMO technique may be additionally applied to at least one of downlink and uplink. When the OFDMA technique is used, the multiple channels may be simultaneously used by not one terminal but multiple terminals without the limit by the primary channel rule. Therefore, the wider bandwidth may be operated to improve efficiency of operating a wireless resource.

As described above, in case the uplink transmission performed by each of the multiple STAs (e.g., non-AP STAs) is performed within the frequency domain, the AP may allocate different frequency resources respective to each of the multiple STAs as uplink transmission resources based on OFDMA. Additionally, as described above, the frequency resources each being different from one another may correspond to different subbands (or sub-channels) or different resource units (RUs).

The different frequency resources respective to each of the multiple STAs are indicated through a trigger frame.

FIG. 8 is a block diagram illustrating one example of HE-SIG-B according to an embodiment.

As illustrated in FIG. 8, the HE-SIG-B field includes a common field at a frontmost part and the corresponding common field is separated from a field which follows therebehind to be encoded. That is, as illustrated in FIG. 8, the HE-SIG-B field may include a common field including the common control information and a user-specific field including user-specific control information. In this case, the common field may include a CRC field corresponding to the common field, and the like and may be coded to be one BCC block. The user-specific field subsequent thereafter may be coded to be one BCC block including the “user-specific field” for 2 users and a CRC field corresponding thereto as illustrated in FIG. 8.

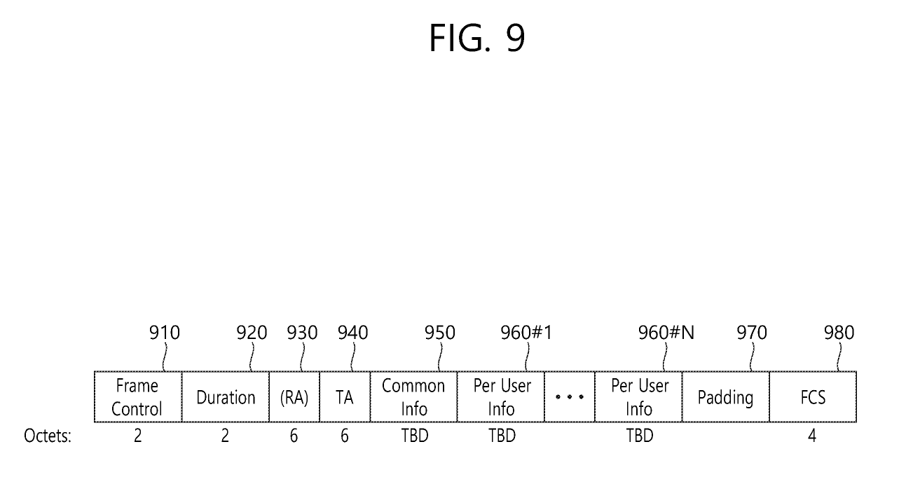

FIG. 9 illustrates an example of a trigger frame. The trigger frame of FIG. 9 allocates resources for Uplink Multiple-User (MU) transmission and may be transmitted from the AP. The trigger frame may be configured as a MAC frame and may be included in the PPDU. For example, the trigger frame may be transmitted through the PPDU shown in FIG. 3, through the legacy PPDU shown in FIG. 2, or through a certain PPDU, which is newly designed for the corresponding trigger frame. In case the trigger frame is transmitted through the PPDU of FIG. 3, the trigger frame may be included in the data field shown in the drawing.

Each of the fields shown in FIG. 9 may be partially omitted, or other fields may be added. Moreover, the length of each field may be varied differently as shown in the drawing.

A Frame Control field (910) shown in FIG. 9 may include information related to a version of the MAC protocol and other additional control information, and a Duration field (920) may include time information for configuring a NAV or information related to an identifier (e.g., AID) of the user equipment.

In addition, the RA field (930) may include address information of the receiving STA of a corresponding trigger frame, and may be optionally omitted. The TA field (940) includes address information of an STA (e.g., AP) for transmitting the trigger frame, and the common information field (950) includes common control information applied to the receiving STA for receiving the trigger frame.

It is preferable that the trigger frame of FIG. 9 includes per user information fields (960#1 to 960#N) corresponding to the number of receiving STAs receiving the trigger frame of FIG. 9. The per user information field may also be referred to as a “RU Allocation field”.

Additionally, the trigger frame of FIG. 9 may include a Padding field (970) and a Sequence field (980).

It is preferable that each of the per user information fields (960#1 to 960#N) shown in FIG. 9 further includes multiple sub-fields.

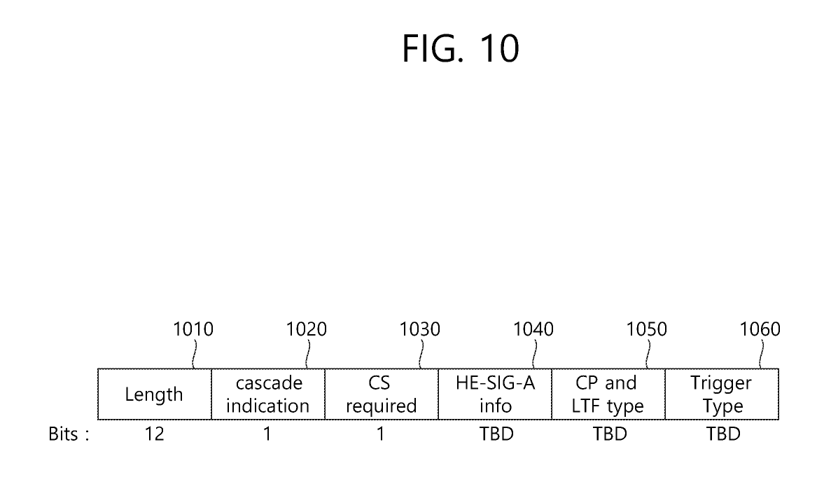

FIG. 10 illustrates an example of a sub-field included in a per user information field. Some parts of the sub-field of FIG. 10 may be omitted, and extra sub-fields may be added. Further, a length of each of the sub-fields shown herein may change.

As shown in the drawing, the Length field (1010) may be given that same value as the Length field of the L-SIG field of the uplink PPDU, which is transmitted in response to the corresponding trigger frame, and the Length field of the L-SIG field of the uplink PPDU indicates the length of the uplink PPDU. As a result, the Length field (1010) of the trigger frame may be used for indicating the length of its respective uplink PPDU.

Additionally, a Cascade Indicator field (1020) indicates whether or not a cascade operation is performed. The cascade operation refers to a downlink MU transmission and an uplink MU transmission being performed simultaneously within the same TXOP. More specifically, this refers to a case when a downlink MU transmission is first performed, and, then, after a predetermined period of time (e.g., SIFS), an uplink MU transmission is performed. During the cascade operation, only one transmitting device performing downlink communication (e.g., AP) may exist, and multiple transmitting devices performing uplink communication (e.g., non-AP) may exist.

A CS Request field (1030) indicates whether or not the status or NAV of a wireless medium is required to be considered in a situation where a receiving device that has received the corresponding trigger frame transmits the respective uplink PPDU.

A HE-SIG-A information field (1040) may include information controlling the content of a SIG-A field (i.e., HE-SIG-A field) of an uplink PPDU, which is being transmitted in response to the corresponding trigger frame.

A CP and LTF type field (1050) may include information on an LTF length and a CP length of the uplink PPDU being transmitted in response to the corresponding trigger frame. A trigger type field (1060) may indicate a purpose for which the corresponding trigger frame is being used, e.g., general triggering, triggering for beamforming, and so on, a request for a Block ACK/NACK, and so on.

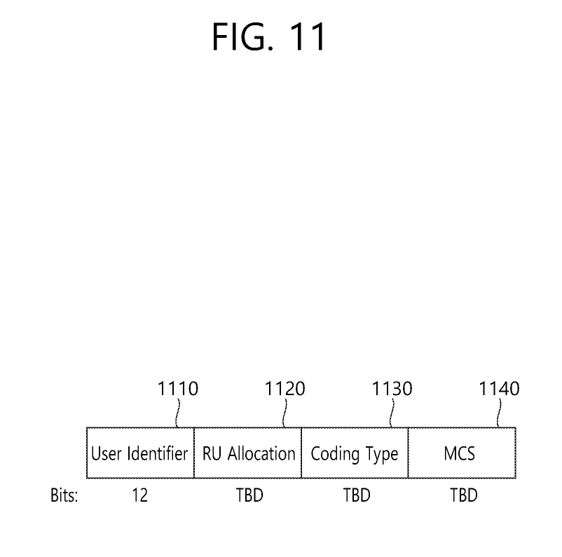

FIG. 11 illustrates an example of a sub-field being included in a per user information field. Among the sub-fields of FIG. 11, some (or part) of the sub-fields may be omitted, and other additional sub-fields may also be added. Additionally, the length of each of the sub-fields shown in the drawing may be varied.

A User Identifier field (1110) of FIG. 11 indicates an identifier of an STA (i.e., receiving STA) to which the per user information corresponds, and an example of the identifier may correspond to all or part of the AID.

Additionally, a RU Allocation field (1120) may be included in the sub-field of the per user information field. More specifically, in case a receiving STA, which is identified by the User Identifier field (1110), transmits an uplink PPDU in response to the trigger frame of FIG. 9, the corresponding uplink PPDU is transmitted through the RU, which is indicated by the RU Allocation field (1120). In this case, it is preferable that the RU that is being indicated by the RU Allocation field (1120) corresponds to the RU shown in FIG. 4, FIG. 5, and FIG. 6.

The sub-field of FIG. 11 may include a Coding Type field (1130). The Coding Type field (1130) may indicate a coding type of the uplink PPDU being transmitted in response to the trigger frame of FIG. 9. For example, in case BBC coding is applied to the uplink PPDU, the Coding Type field (1130) may be set to ‘1’, and, in case LDPC coding is applied to the uplink PPDU, the Coding Type field (1130) may be set to ‘0’.

Additionally, the sub-field of FIG. 11 may include an MCS field (1140). The MCS field (1140) may indicate an MCS scheme being applied to the uplink PPDU that is transmitted in response to the trigger frame of FIG. 9.

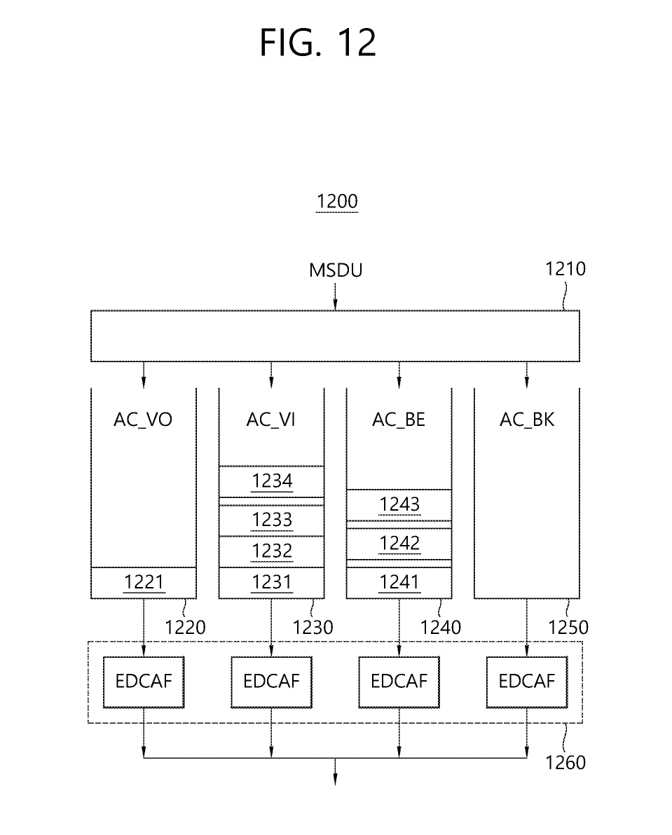

FIG. 12 illustrates a conceptual diagram of an STA performing an EDCA-based channel access in a WLAN system according to an exemplary embodiment of this specification. In the WLAN system, an STA (or AP) performing enhanced distributed channel access (EDCA) may perform channel access according to a plurality of user priority levels that are defined for the traffic data.

The EDCA for the transmission of a Quality of Service (QoS) data frame based on the plurality of user priority levels may be defined as four access categories (hereinafter referred to as ‘AC’s) (background (AC_BK), best effort (AC_BE), video (AC_VI), and voice (AC_VO)).

An STA performing channel access based on the EDCA may map the traffic data, i.e., MAC service data unit (MSDU), departing from a logical link control (LLC) layer and reaching (or arriving at) a medium access control (MAC) layer, as shown below in Table 1. Table 1 is an exemplary table indicating the mapping between user priority levels and ACs.

TABLE 1

| Priority | User priority | Access category (AC) |
|---|---|---|
| Low | 1 | AC_BK |
| | 2 | AC_BK |
| | 0 | AC_BE |
| | 3 | AC_BE |
| | 4 | AC_VI |
| | 5 | AC_VI |
| | 6 | AC_VO |
| High | 7 | AC_VO |

A transmission queue and an AC parameter may be defined for each AC. The plurality of user priority levels may be implemented based on AC parameter values, which are differently configured for each AC.

When performing a backoff procedure for transmitting a frame belonging to each AC, the STA performing channel access based on the EDCA may use each of an arbitration interframe space (AIFS)[AC], a CWmin[AC], and a CWmax[AC] instead of a DCF interframe space (DIFS), a CWmin, and a CWmax, which correspond to parameters for a backoff procedure that is based on a distributed coordination function (DCF).

The EDCA parameters being used in the backoff procedure for each AC may be configured to have a default value or may be loaded in a beacon frame so as to be delivered to each STA from the AP. Additionally, as the values of the AIFS[AC] and the CWmin[AC] become lower (or smaller), since the delay time (or latency time) for the channel access becomes shorter, the corresponding STA may have a higher priority level, and, accordingly, a larger number of bands may be used in the given traffic environment.

The EDCA parameter set element may include information on channel access parameters for each AC (e.g., AIFS [AC], CWmin[AC], CWmax[AC]).

In a case where a collision occurs between the STAs, while the STA is transmitting a frame, the backoff procedure of the EDCA, which generates a new backoff count, is similar to the backoff procedure of the conventional (or legacy) DCF. However, the backoff procedure of the EDCA, which is differentiated for each AC, may be performed based on the EDCA parameters being individually distinguished for each AC. The EDCA parameter may function as an important means that is used for distinguishing (or differentiating) the channel access of traffic corresponding to the diverse user priority levels.

An adequate configuration of EDCA parameter values being defined for each AC may optimize network performance (or capability) and may also increase a transmission effect according to the priority level of the traffic at the same time. Therefore, the AP may be capable of performing a function of overall management and control of EDCA parameters in order to ensure a fair medium access to all STAs participating in the network.

Referring to FIG. 12, one STA (or AP) (1200) may include a virtual mapper (1210), a plurality of transmission queues (1220˜1250), and a virtual collision handler (1260).

The virtual mapper (1210) of FIG. 12 may perform a function of mapping an MSDU that is received from a logical link control (LLC) layer to transmission queues corresponding to each AC in accordance with Table 1, which is presented above.

The plurality of transmission queues (1220˜1250) of FIG. 12 may perform the functions of individual EDCA contention entities for wireless media access within an STA (or AP).

For example, the transmission queue (1220) of the AC_VO type of FIG. 12 may include one frame (1221) for a second STA (not shown). The transmission queue (1230) of the AC_VI type may include 3 frames (1231˜1233) for a first STA (not shown) and one frame (1234) for a third STA in accordance with a transmission order by which the frames are to be transmitted to a physical layer.

The transmission queue (1240) of the AC_BE type of FIG. 12 may include one frame (1241) for a second STA (not shown), and one frame (1242) for a third STA (not shown), and one frame (1243) for a second STA (not shown) in accordance with a transmission order by which the frames are to be transmitted to a physical layer.

As an example, the transmission queue (1250) of the AC_BK type of FIG. 12 may not include a frame that is to be transmitted to a physical layer.

If two or more ACs each having completed the backoff procedure exist in the STA at the same time, collision between the ACs may be adjusted (or controlled) in accordance with an EDCA function (EDCAF), which is included in the virtual collision handler (1260). More specifically, the frame belonging to the AC having the highest priority level may be transmitted beforehand, and other ACs may increase the contention window values and may update the backoff count.

A transmission opportunity (TXOP) may be initiated (or started) when a channel is accessed in accordance with an EDCA rule. When two or more frames are accumulated in one AC, and if an EDCA TXOP is acquired, the AC of an EDCA MAC layer may attempt to perform multiple frame transmissions. If the STA has already transmitted one frame, and if the STA is also capable of transmitting a next frame existing in the same AC within the remaining TXOP time and then capable of receiving its respective ACK, the STA may attempt to perform the transmission of the corresponding next frame after an SIFS time interval.

A TXOP limit value may be configured as a default value in the AP and the STA, or a frame that is related to the TXOP limit value may be transported (or delivered) to the STA from the AP.

If the size of the data frame that is to be transmitted exceeds the TXOP limit value, the AP may perform fragmentation on the corresponding frame into a plurality of smaller frames. Subsequently, the fragmented frames may be transmitted within a range that does not exceed the TXOP limit value.

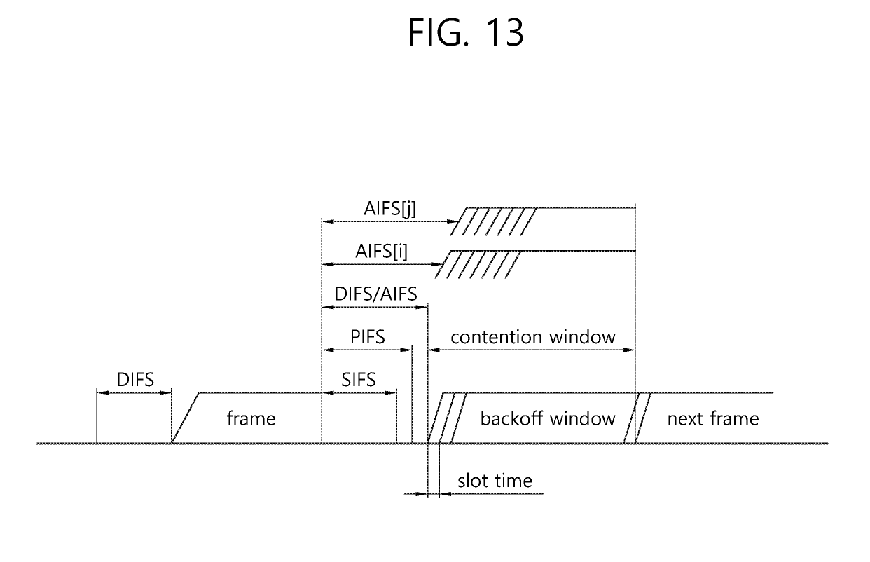

FIG. 13 is a conceptual diagram illustrating a backoff procedure of an EDCA in a WLAN system according to an exemplary embodiment of this specification. * Referring to FIG. 12 and FIG. 13, each traffic data being transmitted from the STA may be assigned with a priority level, and a backoff procedure may be performed based on a contention based EDCA method. For example, the priority levels being assigned to each traffic may be divided into 8 different levels, as shown in Table 1, which is presented above.

As described above, one STA (or AP) may have different output queues (or transmission queues) in accordance with the priority levels, and each output queue operates in accordance with the EDCA rule. Each output queue may transmit traffic data by using a different Arbitration Interframe Space (AIFS) in accordance with each priority level instead of using the conventionally used DCF Interframe Space (DIFS).

Additionally, in case an STA (or AP) is scheduled to transmit traffic each having a different priority level at a same time, collision within the STA (or AP) may be prevented by performing transmission starting from the traffic having a higher priority level.

Each STA (or AP) may configure a backoff time (Tb[i]) to a backoff counter in order to initiate (or start) the backoff procedure. The backoff time (Tb[i]) may be calculated as a pseudo-random integer value by using Equation 1 shown below.

T_{b}[i]=Random(i)×SlotTime Equation 1

Herein, Random(i) refers to a function generating a random integer between 0 and CW[i] by using uniform distribution. CW[i] represents a contention window existing between a minimum contention window CWmin[i] and a maximum contention window CWmax[i], and i represents a traffic priority level.

When a frame is transmitted from an STA performing the backoff procedure, in case a re-transmission is required to be performed due to the occurrence of a collision, Equation 2, which is shown below, may be used. More specifically, each time a collision occurs, a new contention window CWnew[i] may be calculated by using a previous (or old) window CWold[i].

CW_{new}[i]=((CW_{old}[i]+1)×PF)−1 Equation 2

Herein, the PF value may be calculated in accordance with a procedure that is defined in the IEEE 802.11e standard. For example, the PF value may be configured to be equal to ‘2’. Each of the CWmin[i] and AIFS[i] values, which correspond to EDCA parameters, and the PF value may be configured as default values in each STA (or AP) or may be transmitted from the AP by using a QoS parameter set element, which corresponds to a management frame.

Hereinafter, in the exemplary embodiment of this specification, the device (or terminal) may correspond to an apparatus that is capable of supporting both the wireless LAN system and the cellular system. More specifically, the device may be interpreted as a UE supporting the cellular system or as an STA supporting the wireless LAN system.

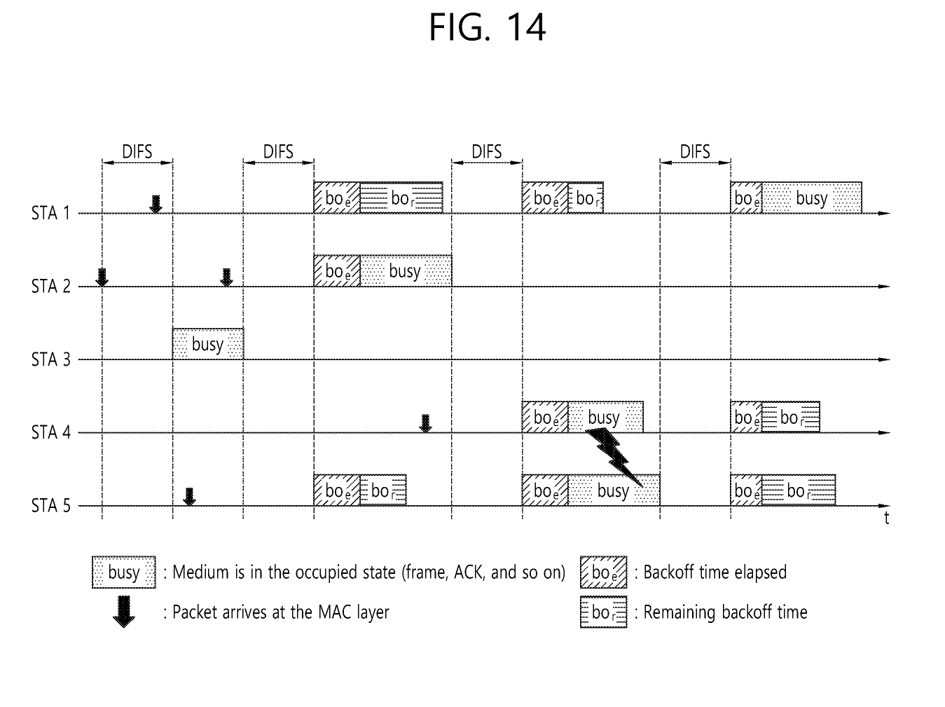

Based on Equation 1 and Equation 2, which are presented above, when the backoff procedure of the transmission queue (1230) of the AC_VI type of FIG. 14 is ended (or completed) beforehand, the transmission queue (1230) of the AC_VI type may acquire a transmission opportunity (hereinafter referred to as ‘TXOP’) allowing access to the medium.

The AP (1200) of FIG. 12 may determine the transmission queue (1230) of the AC_VI type as a primary AC and may determine the remaining transmission queues (1220, 1240, 1250) as secondary ACs.

As described above, a process of performing a backoff procedure on the plurality of transmission queues (1220˜1250) and determining the transmission queue having its backoff procedure completed beforehand as the primary AC may be referred to as a primary AC rule.

A transmission opportunity section according to a transmission opportunity (TXOP) may be determined based on the primary AC, which is determined in accordance with the above-described primary AC rule. Additionally, frames that are included in a secondary AC may also be transmitted in the transmission opportunity section, which is determined based on the primary AC.

FIG. 14 is a diagram for describing a backoff cycle and a frame transmission procedure in a WLAN system of this specification.

A horizontal axis of a first STA (1410) shown in FIG. 14 indicates time (t1), and a vertical axis indicates an occupation status of a corresponding medium. A horizontal axis of a second STA (1420) indicates time (t2), and a vertical axis indicates an occupation status of a corresponding medium. A horizontal axis of a third STA (1430) indicates time (t3), and a vertical axis indicates an occupation status of a corresponding medium. A horizontal axis of a fourth STA (1440) indicates time (t4), and a vertical axis indicates an occupation status of a corresponding medium. And, a horizontal axis of a fifth STA (1450) indicates time (t5), and a vertical axis indicates an occupation status of a corresponding medium.

Referring to FIG. 13 and FIG. 14, when a specific medium is shifted from an occupied or busy state to an idle state, a plurality of STAs may attempt to perform data (or frame) transmission. At this point, as a solution for minimizing collision between the STAs, each STA may select a backoff time (Tb[i]) and may attempt to perform transmission after standing-by (or waiting) during a slot time corresponding to the selected backoff time.

When the backoff procedure is initiated (or started), each STA may perform countdown of the selected backoff count time in slot time units. Each STA may continuously monitor the medium while performing the countdown. If the medium is monitored while being in the Occupied state, the STA may suspend the countdown and be on stand-by (or wait). If the medium is monitored while being in the Idle state, the STA may resume the countdown.

Referring to FIG. 14, when a packet for the third STA (1430) reaches a MAC layer of the third STA (1430), the third STA (1430) may verify (or confirm) whether or not the medium is in the Idle state during a DIFS. Subsequently, if it is determined that the medium is in an Idle state during a DIFS, the third STA (1430) may transmit a frame to an AP (not shown). Herein, although a DIFS is illustrated as an inter frame space (IFS) in FIG. 14, it should be understood that this specification will not be limited only to this.

Meanwhile, the remaining STAS may monitor the Busy state of the medium and may then go on stand-by (or wait). In the meantime, data that are to be transmitted from each of the first STA 91410), the second STA (1420), and the fifth STA (1450) may be generated. When each STA monitors the Idle state of medium, each STA may go on stand-by (or wait) for as long as one DIFS and may, then, perform countdown of a backoff time, which is individually selected by each STA.

Referring to FIG. 14, the drawing shows an exemplary case where the second STA (1420) selects a shortest backoff time (or a smallest backoff time value), and wherein the first STA (1410) selects a longest backoff time (or a largest backoff time value). At a time point where the backoff procedure for the backoff time, which is selected by the second STA (1420), is ended and where a frame transmission is initiated (or started), FIG. 14 shows an exemplary case where the remaining backoff time of the fifth STA (1450) is shorter than the remaining backoff time of the first STA (1410).

When the medium is occupied by the second STA (1420), the first STA (1410) and the fifth STA (1450) may suspend their backoff procedures and may be on stand-by. Thereafter, when the medium occupation of the second STA (1420) is completed (or ended) and the medium returns to the Idle state, the first STA (1410) and the fifth STA (1450) may be on stand-by for as long as a DIFS. Afterwards, the corresponding STAs may resume heir backoff procedures, which were suspended earlier, based on the remaining backoff time. In this case, since the remaining backoff time of the fifth STA (1450) is shorter than the remaining backoff time of the first STA (1410), the fifth STA (1450) may complete the frame transmission earlier than the first STA (1410).

Meanwhile, when the medium is occupied by the second STA (1420), the data that are to be transmitted by the fourth STA (1440) in the meantime may reach a MAC layer of the fourth STA (1440). When the medium returns to its Idle state, the fourth STA (1440) may be on stand-by for as long as a DIFS. Thereafter, the fourth STA (1440) may perform the backoff procedure by counting down the backoff time, which is selected by the fourth STA (1440).

Subsequently, the remaining backoff time of the fifth STA (1450) may coincidently be identical to the backoff time of the fourth STA (1440), thereby causing a collision to occur between the fourth STA (1440) and the fifth STA (1450). When a collision occurs between the STAs, both the fourth STA (1440) and the fifth STA (1450) may fail to receive ACKs and may also fail to perform data transmission.

Accordingly, the fourth STA (1440) and the fifth STA (1450) may individually calculate a new contention window (CWnew[i]) according to Equation 2, which is presented above. Subsequently, the fourth STA (1440) and the fifth STA (1450) may individually perform countdown of the backoff time, which is newly calculated in accordance with Equation 1, which is presented above.

Meanwhile, while the medium is in an Occupied state due to the transmission performed by the fourth STA (1440) and the fifth STA (1450), the first STA (1410) may be on stand-by. Subsequently, when the medium returns to the Idle state, the first STA (1410) may be on stand-by for as long as a DIFS and may, then, resume the backoff counting. And, when the remaining backoff time is elapsed, the first STA (1410) may transmit a frame.

A CSMA/CA mechanism may also include virtual carrier sensing in addition to physical carrier sensing, wherein the AP and/or STA directly senses the medium.

Virtual carrier sensing is performed to compensate problems that may occur during medium access, such as a hidden node problem, and so on. In order to perform virtual carrier sensing, a MAC of the WLAN system uses a Network Allocation Vector (NAV). The NAV corresponds to a value that is indicated by an AP and/or an STA that is currently using the medium or that has the authority to use the medium to another AP and/or STA, wherein the value indicates the time remaining until the medium returns to its state of being available for usage. Accordingly, a value that is set as the NAV corresponds to a time period during which the usage of the medium is scheduled by the AP and/or STA, which transmits the corresponding frame, and the STA receiving the NAV value is prohibited from accessing the medium during the corresponding time period. For example, the NAV may be configured in accordance with a value of the duration field of the MAC header of the corresponding frame.

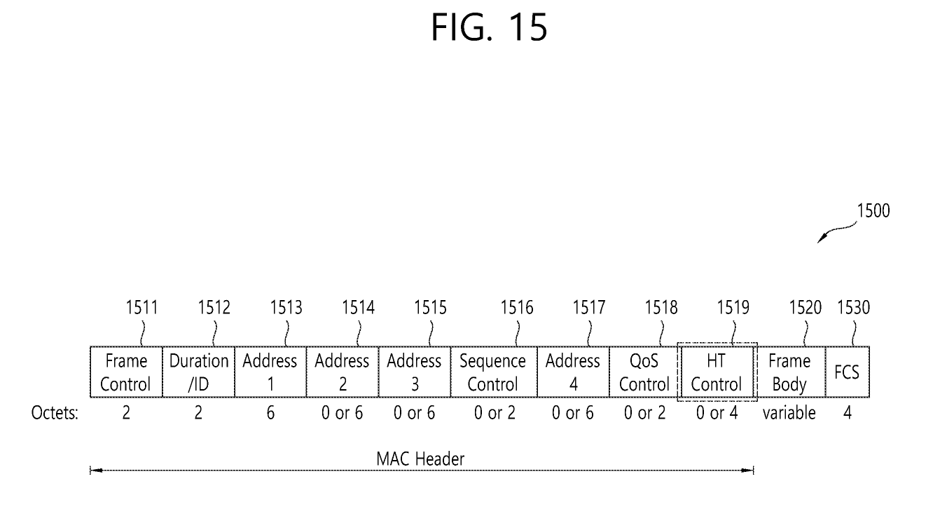

FIG. 15 illustrates an example of a MAC frame for reporting a buffer status according to an exemplary embodiment of this specification.

A MAC frame (1500) according to the exemplary embodiment of this specification may include a plurality of fields (1511˜1519) configuring a MAC header, a frame body field (1520) including a payload and having a variable length, and an FCS field (1530) for error detection of a receiving device.

In the MAC header, a frame control field (1511), a duration/ID field (1512), a first address field (1513), and the FCS field (1530) may be included in all types of MAC frames.

Conversely, a second address field (1514), a third address field (1515), a sequence control field (1516), a fourth address field (1517), a QoS control field (1518), a HT control field (1519), and a frame body field (1520) may be selectively included in accordance with the type of the MAC frame.

When a QoS data frame or a QoS null frame is indicated by the frame control field (1511), the QoS control field (1518) may be included in the MAC frame.

The QoS control field (1518) is configured of 2 octets (16 bits). The QoS control field (1518) may be configured as shown below in Table 2.

TABLE 2

| Applicable frame | Bits | | | | | | | |
|---|---|---|---|---|---|---|---|---|
| (sub) types | 0-3 | Bit 4 | Bits 5-6 | Bit 7 | Bits 8 | Bit 9 | Bit 10 | Bits 11-15 |

| | | | | | |
|---|---|---|---|---|---|
| QoS Data and QoS Data + | TID | 0 | Ack | A-MSDU | TXOP Duration Requested |
| CP-Ack frames sent by | | | Policy | Present | |
| non-AP STAs that are not a | TID | 1 | Ack | A-MSDU | Queue Size |
| TPU buffer STA or a TPU | | | Policy | Present | |
| sleep STA in a nonmesh | | | | | |
| BSS | | | | | |
| QoS Null frames sent by | TID | 0 | Ack | Reserved | TXOP Duration Requested |
| non-AP STAs that are not a | | | Policy | | |
| TPU buffer STA or a TPU | TID | 1 | Ack | Reserved | Queue Size |
| sleep STA in a nonmesh | | | Policy | | |
| BSS | | | | | |

Referring to Table 2, first to fourth bits (Bits0-3) may correspond to a region for a traffic identifier (hereinafter referred to as ‘TID’). The user priority levels (0-7) for the traffic identifier (TID) information may be mapped to values of ‘0’ to ‘7’, which can be expressed by using first to fourth bits (Bits0-3). The remaining values ‘8’ to ‘15’, which can be expressed by the first to fourth bits (Bits0-3), may be reserved.

More specifically, the STA (or AP) may announce (or notify) traffic identifier (TID) information corresponding to the traffic that is being buffered to the STA through the first bit to the fourth bit (Bits0-3) of the QoS control field (1518).

If the fifth bit (Bit4) of the QoS control field (1518) is set to ‘1’, the ninth bit to sixteenth bit (Bit8-Bit15) of the QoS control field (1518) may indicate queue size information of the traffic being buffered to the queue of the corresponding STA.

In case multiple buffered traffic exist in the STA, the STA may notify (or announce) queue size information to the buffered traffic based on the HT control field (1519) of the MAC frame (1500).

A method for reporting information related to the buffered traffic (i.e., buffer status information) of a user STA by using the HT control field (1519) will hereinafter be described in more detail with reference to the accompanying drawings.

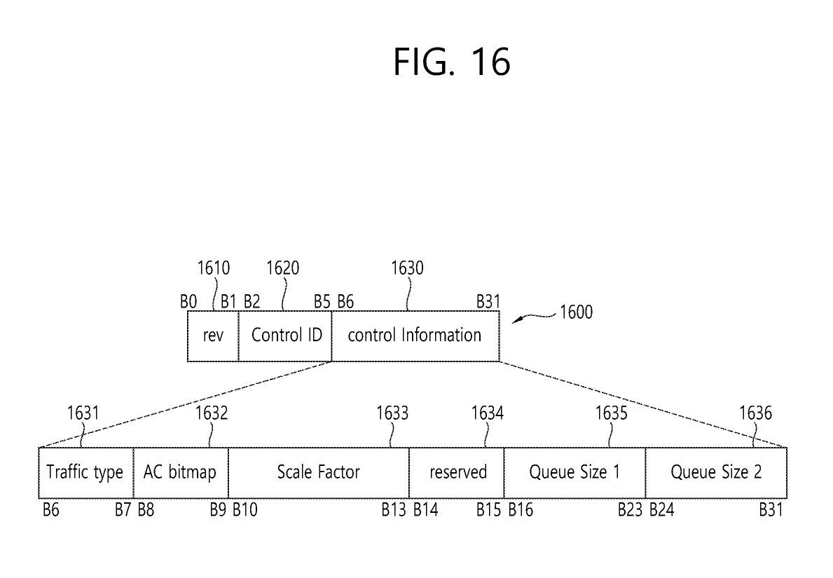

FIG. 16 is a diagram illustrating a field region of a MAC frame for reporting a buffer status according to an exemplary embodiment of this specification.

Referring to FIG. 1 to FIG. 16, if a first bit and a second bit (1610, B0-B1) of the HT control field (1600, 1519 of FIG. 15) according to the exemplary embodiment of this specification are set to ‘11’, the remaining bits (B2-B31) of the HT control field (1600) may be assigned for an A-Control field (1620, 1630).

The control ID field (1620, B2-B5) may indicate a type of the information being included in the control information field (1630). The control information field (1630), which is related to the value of the control ID field (1620), may be defined as shown below in Table 3.

TABLE 3

| | | Length of the Control |
|---|---|---|
| Control ID | | Information subfield |
| value | Meaning | (bits) |
| 0 | UL MU response scheduling | 26 |
| 1 | Operating Mode | 12 |
| 2 | HE link adaptation | 16 |
| 3 | Buffer Status Report (BSR) | 26 |
| 4 | UL Power Headroom | 8 |
| 5 | Bandwidth Query Report (BQR) | 10 |
| 6-15 | Reserved | — |

Referring to Table 3, when the control ID field (1620) is set to ‘1’, the control information field (1630) may indicate information for requesting a change (or shift) in the operating mode of the STA that transmits a frame based on 12 bits.

When the control ID field (1620, B2-B5) is set to ‘3’, the control information field (1630) may indicate may indicate information for a buffer status report (hereinafter referred to as ‘BSR’) of the STA, which transmits a frame based on 26 bits.

Hereinafter, in this specification, it will be assumed that the control ID field (1620) is set to ‘3’. Therefore, first to sixth sub-fields (1631˜1636) for the buffer status information may be included in the control information field (1630).

For a more detailed understanding of the buffer status information, which is mentioned in this specification, reference may be made to Section 9.2.4.6.4.5 and Section 27.5.2.5 of the standard document IEEE P802.11ax/D1.0, which was disclosed in November 2016.

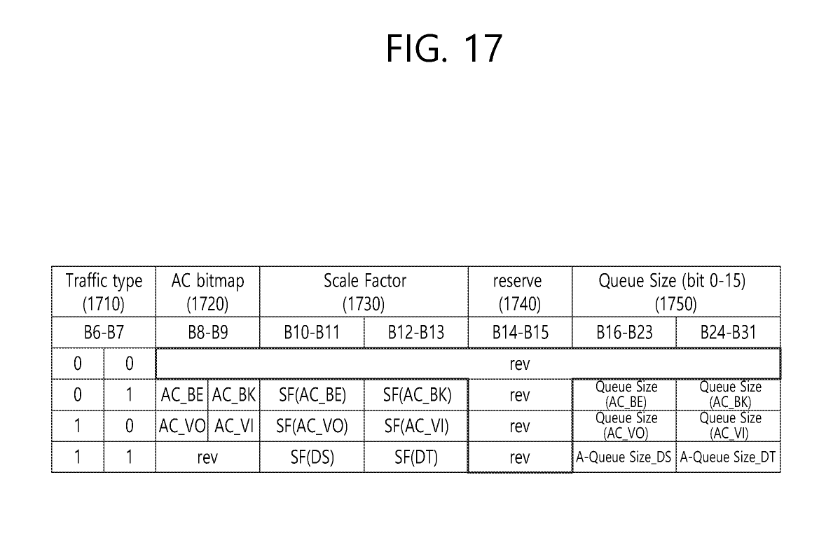

FIG. 17 is a diagram illustrating detailed operations of reporting a buffer status of a user STA based on buffer status information included in a control information field according to an exemplary embodiment of this specification.

Referring to FIG. 16 and FIG. 17, a traffic type field (1710) of FIG. 17 may be configured of 2 bits (B6-B7) and may correspond to the first sub-field (1631) of FIG. 16. The traffic type field (1710) may indicate traffic urgency such as delay sensitive (hereinafter referred to as ‘DS’) traffic or delay tolerance (hereinafter referred to as ‘DT’) traffic.

For example, if the 2-bit (B6-B7) traffic type field (1710) is set to ‘01’, this may indicate a delay tolerance (DT) traffic. In this case, the delay tolerance (DT) traffic may correspond to traffic being associated with the AC_BK type or the AC_BE type.

For example, if the 2-bit (B6-B7) traffic type field (1710) is set to ‘10’, this may indicate a delay sensitive (DS) traffic. In this case, the delay sensitive (DS) traffic may correspond to traffic being associated with the AC_VI type or the AC_VO type.

For example, if the 2-bit (B6-B7) traffic type field (1710) is set to ‘11’, this may indicate both the delay tolerance (DT) traffic and the delay sensitive (DS) traffic. In this case, the queue size information, which will be described later on in more detail, may be respectively indicated as a total sum of the delay tolerance (DT) traffic and a total sum of the delay sensitive (DS) traffic.

For example, if the 2-bit (B6-B7) traffic type field (1710) is set to ‘00’, the remaining region of the control information field (B8-B31) may correspond to a reserved region.

Alternatively, although it is not shown in FIG. 17, in case the traffic type field (1710) is set to ‘00’, the remaining region of the control information field may be used for announcing (or notifying) a buffer status wherein all of the frames being related to all types of traffic identifiers (TIDs) (0-7) are aggregated.

An AC bitmap field (1720) of FIG. 20 may be configured of 2 bits (B8-B9) and may correspond to the second sub-field (1632) of FIG. 16.

The AC bitmap field (1720) may be associated with the traffic type field (1710) and may indicate an access category (AC) bitmap.

More specifically, when the delay tolerance (DT) traffic is indicated by the traffic type field (1710), the AC bitmap field (1720) may indicate the presence of the AC_BE type and AC_BK type traffic.

For example, when the 2-bit (B8-B9) AC bitmap field (1720) is set to ‘01’, the presence of the AC_BK type traffic may be indicated. When the 2-bit (B8-B9) AC bitmap field (1720) is set to ‘10’, the presence of the AC_BE type traffic may be indicated. And, when the 2-bit (B8-B9) AC bitmap field (1720) is set to ‘11’, the presence of both the AC_BK type traffic and the AC_BE type traffic may be indicated.

More specifically, when the delay sensitive (DS) traffic is indicated by the traffic type field (1710), the AC bitmap field (1720) may indicate the presence of the AC_VO type and AC_VI type traffic.

For example, when the 2-bit (B8-B9) AC bitmap field (1720) is set to ‘01’, the presence of the AC_VI type traffic may be indicated. When the 2-bit (B8-B9) AC bitmap field (1720) is set to ‘10’, the presence of the AC_VO type traffic may be indicated. And, when the 2-bit (B8-B9) AC bitmap field (1720) is set to ‘11’, the presence of both the AC_VI type traffic and the AC_VO type traffic may be indicated.

More specifically, when both the delay sensitive (DS) traffic and the delay tolerance (DT) traffic are indicated by the traffic type field (1710), the AC bitmap field (1720) may correspond to a reserved region.

The scale factor field (1730) of FIG. 17 is configured of 4 bits (B10-B13) and may correspond to the third sub-field (1633) of FIG. 16. The scale factor field (1730) may be associated with the traffic type field (1710) and the AC bitmap field (1720), and the scale factor field (1730) may include at least one scaling factor (hereinafter referred to as ‘SF’) for indicating a queue size of the buffered traffic (i.e., the size of the buffered traffic).

The reserved field (1740) of FIG. 17 is configured of 2 bits (B14-B15) and may correspond to the fourth sub-field (1634) of FIG. 16.

The queue size field (1750) of FIG. 17 is configured of 16 bits (B16-B31) and may correspond to the fifth and sixth sub-fields (1635, 1636) of FIG. 16. The queue size field (1750) of FIG. 17 may indicate the queue size of the traffic being buffered to the STA based on the traffic type field (1710), the AC bitmap field (1720), and the scale factor field (1730).

The queue size field (1750) according to an exemplary embodiment of this specification may be indicated based on a predetermined unit size (e.g., 256 octets) and a scale factor configured in the scale factor field (1730).

Referring to FIG. 17, a first scale factor (B10-B11) and a second scale factor (B12-B13) may be included in the 4-bit scale factor field (1730). For example, a weighted value set configured of a combination of 4 weighted values, among ‘1’, ‘32’, ‘64’, ‘128’, ‘256’, ‘512’, and ‘1024’, may be configured for each of the first scale factor (B10-B11) and the second scale factor (B12-B13).

Hereinafter, in order to simplify the description, it will be assumed that a weighted value set of [1, 64, 256, 1024] is configured to the first scale factor (B10-B11) and the second scale factor (B12-B13).

A procedure for selecting an appropriate (or adequate) weighted value in order to indicate the size of the buffered traffic of the user STA based on the weighted value set according to the exemplary embodiment of this specification may be performed by the user STA.

For example, a queue size of a traffic having a higher transmission priority level may generally be smaller than a queue size of a traffic having a lower transmission priority level.

Therefore, it may be preferable to use a relatively smaller weighted value, among the weighted value set of [1, 64, 256, 1024], in order to indicate the queue size of the traffic having the higher transmission priority level.

Additionally, it may be preferable to use a relatively greater weighted value, among the weighted value set of [1, 64, 256, 1024], in order to indicate the queue size of the traffic having the lower transmission priority level.

For example, in order to indicate a total size of the buffered traffic to the transmission queue of the AC_VO type, the user STA may configure ‘1’ as the scaling factor (SF), among [1, 64, 256, 1024]. More specifically, in the buffer status information being transmitted to the AP by the user STA, the actual size of the traffic being buffered to the transmission queue of the AC_VO type of the user STA may be expressed as 1(SF)* 256(octets)*a value (B16-B23) corresponding to the queue size field of the AC_VO type.

In order to indicate a total size of the buffered traffic to the transmission queue of the AC_VI type, the user STA may configure ‘64’ as the scaling factor (SF), among [1, 64, 256, 1024]. More specifically, in the buffer status information being transmitted to the AP by the user STA, the actual size of the traffic being buffered to the transmission queue of the AC_VI type of the user STA may be expressed as 64(SF)* 256(octets)*a value (B24-B31) corresponding to the queue size field of the AC_VI type.

In order to indicate a total size of the buffered traffic to the transmission queue of the AC_BE type, the user STA may configure ‘256’ as the scaling factor (SF), among [1, 64, 256, 1024]. More specifically, in the buffer status information being transmitted to the AP by the user STA, the actual size of the traffic being buffered to the transmission queue of the AC BE type of the user STA may be expressed as 256(SF)*256(octets)*a value (B16-B23) corresponding to the queue size field of the AC_BE type.

In order to indicate a total size of the buffered traffic to the transmission queue of the AC_BK type, the user STA may configure ‘1024’ as the scaling factor (SF), among [1, 64, 256, 1024]. More specifically, in the buffer status information being transmitted to the AP by the user STA, the actual size of the traffic being buffered to the transmission queue of the AC BK type of the user STA may be expressed as 1024(SF)*256(octets)*a value (B24-B3) corresponding to the queue size field of the AC_BK type.

Additionally, a queue size of delay sensitive (DS) traffic is generally smaller than a queue size of delay tolerance (DT) traffic. Therefore, in order to indicate a queue size of the delay sensitive (DS) traffic, it may be preferable to use a relatively smaller weighted value, among the weighted value set [1, 64, 256, 1024].

For example, in order to indicate a total size of the delay sensitive (DS) traffic, the user STA may configure ‘64’ as the scaling factor (SF), among [1, 64, 256, 1024]. More specifically, in the buffer status information being transmitted to the AP by the user STA, the actual total size of the delay sensitive (DS) traffic of the user STA may be expressed as 64(SF)*256(octets)*a value (B16-B23) corresponding to the queue size field of the delay sensitive (DS) traffic.

In order to indicate a total size of the delay tolerance (DT) traffic, the user STA may configure ‘1024’ as the scaling factor (SF), among [1, 64, 256, 1024]. More specifically, in the buffer status information being transmitted to the AP by the user STA, the actual total size of the delay tolerance (DT) traffic of the user STA may be expressed as 1024(SF)*256(octets) *a value (B24-B31) corresponding to the queue size field of the delay tolerance (DT) traffic.

The weighted values and/or weighted value set being mentioned in FIG. 17 are merely exemplary. And, therefore, it should be understood that other weighted values and/or weighted value set may also be applied in accordance with the size of the buffered traffic or type of the buffered traffic of the user STA.

Although it is not shown in FIG. 17, one scale factor (B10-B13) using 4 bits may be included in the scale factor field (1730). For example, a weighted value set being configured of 4 or more weighted values, among ‘1’, ‘32’, ‘64’, ‘128’, ‘256’, ‘512’, and ‘1024’, may be configured for the one scale factor (B10-B13).

Although the scale factor (B10-B13) of FIG. 17 is configured of 2 bits, this is merely exemplary. And, the scale factor (B10-B13) may each be configured of 1 bit. In the above-described case, a weighted value set being configured of 2 weighted values, among ‘1’, ‘32’, ‘64’, ‘128’, ‘256’, ‘512’, and ‘1024’, may be configured.

As another example, the scale factor (B10-B13) may be configured of 3 bits. In this case, a weighted value set being configured of all 7 weighted values, among ‘1’, ‘32’, ‘64’, ‘128’, ‘256’, ‘512’, and ‘1024’, may be configured.

For example, when the traffic type field (1710) is indicated as ‘10’, and when the AC bitmap field is indicated as ‘10’, 2 bits (B10-B11), among the 4 bits (B10-B13), of the scale factor field (1730) may be configured to be equal to a valid value.

A value, which is calculated by dividing the size of the traffic being buffered to the transmission queue of the AC VO type of the user STA by the weighted value corresponding to the scaling factor field (1730), may be configured to the 8 bits (B16-B23) of the queue size field (1750).

Referring to FIG. 17, when the traffic type field (1710) is indicated as ‘01’, and when the AC bitmap field is indicated as ‘11’, a valid value may be configured to each of the first scaling factor (B10-B11) and the second scaling factor (B12-B13) of the scaling factor field (1730).

A value, which is calculated by dividing the size of the actual traffic being buffered to the transmission queue of the AC_BE type by the weighted value corresponding to the first scaling factor (B10-B11), may be configured to the 8 bits (B16-B23) of the queue size field (1750).

Additionally, a value, which is calculated by dividing the size of the actual traffic being buffered to the transmission queue of the AC_BK type by the weighted value corresponding to the second scaling factor (B12-B13), may be configured to the 8 bits (B24-B31) of the queue size field (1750).

As another example, when the traffic type field (1710) is indicated as ‘01’, and when the AC bitmap field is indicated as ‘11’, a valid value may be configured to each of the first scaling factor (B10-B11) and the second scaling factor (B12-B13) of the scaling factor field (1730).

A value, which is calculated by dividing the size of the actual traffic being buffered to the transmission queue of the AC_VO type by the weighted value corresponding to the first scaling factor (B10-B11), may be configured to the 8 bits (B16-B23) of the queue size field (1750).

Additionally, a value, which is calculated by dividing the size of the actual traffic being buffered to the transmission queue of the AC_VI type by the weighted value corresponding to the second scaling factor (B12-B13), may be configured to the 8 bits (B24-B31) of the queue size field (1750).

As an additional example, when the traffic type field (1710) is indicated as ‘11’, a valid value may be configured to each of the 2 bits (B10-B11) and the 2 bits (B12-B13) of the scaling factor field (1730).

In this case, a value, which is calculated by dividing the total size of a traffic being related to the delay sensitive (DS) traffic of the STA by the weighted value corresponding to the first scaling factor (B10-B11), may be configured to the 8 bits (B16-B23) of the queue size field (1750). For example, the delay sensitive (DS) traffic may correspond to a traffic including the traffic being buffered to the transmission queue of the AC_VO type and the traffic being buffered to the transmission queue of the AC_VI type.

Additionally, a value, which is calculated by dividing the total size of a traffic being related to the delay tolerance (DT) traffic of the STA by the weighted value corresponding to the second scaling factor (B12-B13), may be configured to the 8 bits (B24-B31) of the queue size field (1750). For example, the delay tolerance (DT) traffic may correspond to a traffic including the traffic being buffered to the transmission queue of the AC_BK type and the traffic being buffered to the transmission queue of the AC_BE type.

Although the scaling value for the buffer status report performed by each user STA was determined by the AP in the related art, by referring to the traffic size having a higher transmission priority level, the user STA according to the exemplary embodiment of this specification may configure an adequate (or appropriate) weighted value, among the weighted value set, as the scaling factor (SF).

More specifically, in case the user STA reports its buffer status for uplink scheduling to the AP, the accuracy of the buffer status report being reported to the AP may be enhanced. Therefore, the efficiency in the overall uplink scheduling operation of the WLAN system according to the exemplary embodiment of this specification may be enhanced.

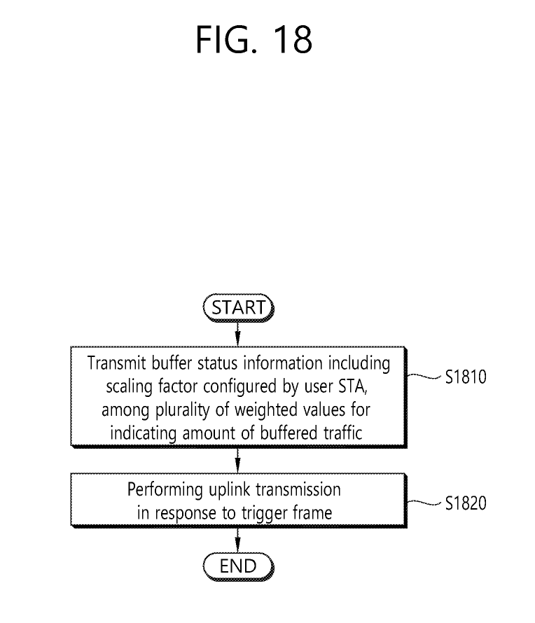

FIG. 18 is a diagram showing an exemplary method for transmitting an uplink frame in a wireless LAN system according to an exemplary embodiment of this specification. Referring to FIG. 1 to FIG. 18, in step S1810, the user STA may transmit buffer status information for reporting the buffer status of the user STA to an access point (AP).

In the exemplary embodiment of this specification, the buffer status information may include a scaling factor (hereinafter referred to as ‘SF’) that is configured by the user STA based on a plurality of weighted values (i.e., a weighted value set) for indicating a traffic size buffered to the user STA. Additionally, in this specification, the traffic size being buffered to the user STA may be mentioned as the buffer status.

For example, the buffer status information may be used for indicating an added (or summed) size of all traffic being buffered to the plurality of transmission queues (1210˜1250) of the user STA (1200) shown in FIG. 12. Additionally, the buffer status information may be used for indicating a traffic size being buffered to a specific transmission queue, among a plurality of transmission queues (1210˜1250), of the user STA (1200) shown in FIG. 12.

Additionally, the size of the buffered traffic according to the exemplary embodiment of this specification may be indicated based on a predetermined unit size and a scaling factor (SF). For example, the predetermined unit size may be equal to 256 octets. Moreover, a weighted value that can be configured to the scaling factor may correspond to ‘1’, ‘32’, ‘64’, ‘128’, ‘256’, ‘512’, or ‘1024’.

According to the exemplary embodiment of this specification, the scaling factor (SF) may be configured of any one of the plurality of weighted values for indicating the traffic size having the highest transmission priority level and being buffered to the user STA.

For example, the user STA may configure an adequate (or appropriate) weighted value, among the plurality of weighted values, for indicating the traffic size included in the transmission queue (e.g., 1220 of FIG. 12) of the AC_VO type of the user STA as the scaling factor (SF).

More specifically, in order to configure an adequate value as the scaling factor (SF), by comparing an actual traffic size being buffered to a specific transmission queue (e.g., 1220 of FIG. 12) of the user STA with a traffic size being expressed based on the predetermined unit size and the plurality of weighted values, the user STA may configure a weighted value, which corresponds to a case where a difference between the actual traffic size and the expressed traffic size is the smallest, as the scaling factor (SF).

As another example, the user STA may configure the most adequate (or appropriate) weighted value, among the plurality of weighted values, for indicating the traffic size included in all transmission queues (e.g., 1220˜1250 of FIG. 12) of the user STA as the scaling factor (SF).

More specifically, in order to configure an adequate value as the scaling factor (SF), by comparing an added (or summed) size of actual traffic being buffered to all transmission queues (e.g., 1220˜1250 of FIG. 12) of the user STA with a traffic size being expressed based on the predetermined unit size and the plurality of weighted values, the user STA may configure a weighted value, which is used in a case where a difference between the actual traffic size and the expressed traffic size is the smallest, as the scaling factor (SF).

The buffer status information of FIG. 18 may correspond to the information being included in the header of the MAC frame, which is described above in FIG. 15. More specifically, the buffer status information of FIG. 18 may be indicated by using 4 octets that are assigned (or allocated) to the HT control field (1519) of FIG. 15.

As described above, the buffer status information being included in the header of the MAC frame may be transmitted as an unsolicited type. More specifically, the buffer status information being included in the header of the MAC frame may correspond to information being transmitted without any request from the AP. As another example, the buffer status information may be included in the QoS control field (1518 of FIG. 15) of the MAC frame.

Additionally, the buffer status information of FIG. 18 may correspond to information being transmitted as a response to a buffer status report poll type trigger frame, which is transmitted by the AP. In this case, the buffer status information may be transmitted as a solicited type. More specifically, the buffer status information, which is being transmitted as a response to the buffer status report poll type trigger frame, may correspond to information being transmitted in accordance with a request from the AP.

Step S1810 is described as a process step during which buffer status information for reporting the buffer status of one user STA is transmitted. It shall be understood that step S1810 may also be separately performed by a plurality of user STAs being associated/non-associated with the AP. More specifically, the AP may perform scheduling for uplink transmission based on the buffer status information received from the plurality of user STAs.

In step S1820, the user STA may receive a trigger frame, which is generated based on the buffer status information transmitted by the user STA, from the AP. In this case, the trigger frame may include a plurality of uplink resource units being separately assigned (or allocated) for the plurality of user STAs.

Subsequently, the user STA may transmit traffic being buffered to the user STA to the AP through an uplink resource unit corresponding to the user STA, among the plurality of uplink resource units being assigned to the trigger frame. For example, the buffered traffic being transmitted by the user STA may correspond to traffic having the highest transmission priority level in the user STA.

According to the exemplary embodiment to this specification, each user STA may report information related to the traffic size being buffered to each user STA to the AP by using an adequate (or appropriate) scaling factor. More specifically, the AP may receive multiple sets of buffer status information having enhanced accuracy from the plurality of user STAs. Thus, according to the exemplary embodiment of this specification, in light of uplink scheduling, a WLAN system having an enhanced performance (or capability) may be provided.

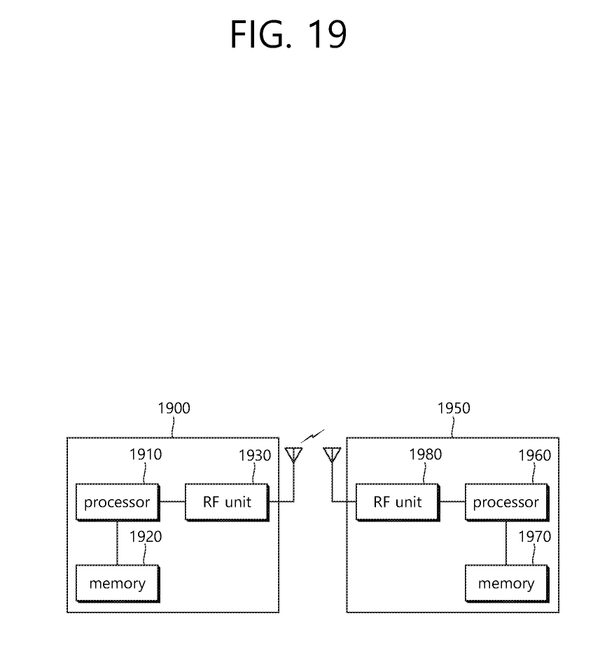

FIG. 19 is a block view illustrating a wireless device to which the exemplary embodiment of this specification can be applied.

Referring to FIG. 19, as an STA that can implement the above-described exemplary embodiment, the wireless device may correspond to an AP or a non-AP station (STA). The wireless device may correspond to the above-described user or may correspond to a transmitting device transmitting a signal to the user.

The AP (1900) includes a processor (1910), a memory (1920), and a radio frequency (RF) unit (1930).

The RF unit (1930) is connected to the processor (1910), thereby being capable of transmitting and/or receiving radio signals.

The processor (1910) implements the functions, processes, and/or methods proposed in this specification. For example, the processor (1910) may be implemented to perform the operations according to the above-described exemplary embodiments of this specification. More specifically, among the operations that are disclosed in the exemplary embodiments of FIG. 1 to FIG. 18, the processor (1910) may perform the operations that may be performed by the AP.

The non-AP STA (1950) includes a processor (1960), a memory (1970), and a radio frequency (RF) unit (1980).

The RF unit (1980) is connected to the processor (1960), thereby being capable of transmitting and/or receiving radio signals.

The processor (1960) implements the functions, processes, and/or methods proposed in this specification. For example, the processor (1960) may be implemented to perform the operations of the non-AP STA according to the above-described exemplary embodiments of this specification. The processor may perform the operations of the non-AP STA, which are disclosed in the exemplary embodiments of FIG. 1 to FIG. 18.

The processor (1910, 1960) may include an application-specific integrated circuit (ASIC), another chip set, a logical circuit, a data processing device, and/or a converter converting a baseband signal and a radio signal to and from one another. The memory (1920, 1970) may include a read-only memory (ROM), a random access memory (RAM), a flash memory, a memory card, a storage medium, and/or another storage device. The RF unit (1930, 1980) may include one or more antennas transmitting and/or receiving radio signals.

When the exemplary embodiment is implemented as software, the above-described method may be implemented as a module (process, function, and so on) performing the above-described functions. The module may be stored in the memory (1920, 1970) and may be executed by the processor (1910, 1960). The memory (1920, 1970) may be located inside or outside of the processor (1910, 1960) and may be connected to the processor (1910, 1960) through a diversity of well-known means.

Although an embodiment of the invention has been described in detail in the present specification, various modifications are possible without departing from the scope of the present specification. Therefore, the scope of the present specification should not be construed as being limited to the aforementioned embodiment, but should be defined by not only claims of the invention described below but also equivalents to the claims.

What is claimed is:

1. A method for uplink transmission in a wireless local area network (WLAN) system performed by a user stations (STA), the method comprising:
transmitting buffer status information for reporting a buffer status of the user STA to an access point (AP), wherein the buffer status information includes a scaling factor being configured by the user STA based on a plurality of weighted values for indicating an amount of traffic being buffered in the user STA; and
if a trigger frame being generated based on the buffer status information is received from the AP, performing uplink transmission in response to the trigger frame, wherein the trigger frame corresponds to a frame including a plurality of uplink resource units being separately assigned for a plurality of user STAs.

2. The method of claim 1, wherein the amount of the buffered traffic is indicated based on a predetermined unit size and the scaling factor.

3. The method of claim 1, wherein the scaling factor is configured to have any one of the plurality of weighted values in accordance with a traffic having a highest transmission priority level in the user STA.

4. The method of claim 1, wherein the buffer status information corresponds to information being included in a header of a medium access control (MAC) frame.

5. The method of claim 1, wherein the step of performing uplink transmission comprises:
transmitting the buffered traffic to the AP by using a resource unit corresponding to the user STA, among the plurality of resource units.

6. The method of claim 1, wherein the buffer status information corresponds to information being transmitted in response to a buffer status report poll type trigger frame received from the AP.

7. The method of claim 1, wherein the trigger frame is a basic type trigger frame.

8. A wireless device using a method for uplink transmission in a wireless local area network (WLAN) system, comprising:
a transceiver transmitting and receiving radio signals; and
a processor being operatively connected to the transceiver,
wherein the processor is configured:
to transmit buffer status information for reporting a buffer status of the user STA to an access point (AP), wherein the buffer status information includes a scaling factor being configured by the user STA based on a plurality of weighted values for indicating an amount of traffic being buffered in the user STA, and
if a trigger frame being generated based on the buffer status information is received from the AP, to perform uplink transmission in response to the trigger frame, wherein the trigger frame corresponds to a frame including a plurality of uplink resource units being separately assigned for a plurality of user STAs.

9. The wireless device of claim 8, wherein the size of the buffered traffic is indicated based on a predetermined unit size and the scaling factor.

10. The wireless device of claim 8, wherein the scaling factor is configured to have any one of the plurality of weighted values in accordance with a traffic having a highest transmission priority level in the user STA.

11. The wireless device of claim 8, wherein the buffer status information corresponds to information being included in a header of a medium access control (MAC) frame.
